(19) United States
(12) Patent Application Publication
(10) Pub. No.: US 2006/0243745 A1
(43) Pub. Date: Nov. 2, 2006

(54) INSULATED DISPENSE TUBE SERVER

(76) Inventors: Jeffrey Doneghue, Sherman, IL (US); Burton L. Hart, Auburn, IL (US); Robert J. Kobylarz, Springfield, IL (US)

Correspondence Address: BARNES & THORNBURG LLP, P.O. BOX 2786, CHICAGO, IL, 60690-2786, US

(21) Appl. No.: 11/380,568

(22) Filed: Apr. 27, 2006

Related U.S. Application Data
(60) Provisional application No. 60/676,416, filed on Apr. 29, 2005.

(51) Int. Cl. B67D 5/06

(52) U.S. Cl. 222/185.1; 222/131; 222/183

(57) ABSTRACT

A server for use with a beverage dispenser, a beverage dispenser including a server, and methods for reducing heat transfer. The server includes an inner wall and an outer wall with the wall defining a gap there between. The inner wall defines a cavity for retaining a volume of beverage. A dispense passage extends between the inner and outer walls and communicates with the cavity for dispensing beverage from the server. A sump may be provided in at least the inner wall. The dispense passage may be configured to communicate with the sump. The dispense passage may be configured to extend from a side of the inner wall or sump through to the side of the outer wall. The dispense passage extends through the gap. An inlet port of the passage communicates with the sump. The sump is sized in dimension in relation to the inlet port to reduce heat transfer from beverage retained in the cavity to the beverage retained in the dispense passage. A faucet may be provided communicating with the dispense passage for controllably dispensing beverage from the server. The server may be in the form of a dispenser which may include external components such as a top and a base.

### CROSS-REFERENCE TO RELATED APPLICATIONS

This patent application claims the benefit of U.S. Provisional Patent Application Nos. 60/676,416 filed Apr. 29, 2005. The disclosure set forth in the referenced provisional application is incorporated herein by reference in its entirety, including all information as originally submitted to the United States Patent and Trademark Office.

### BACKGROUND

A number of dispensing units including servers or containers for retaining beverages and other food substances have been developed. There are generally two different forms of servers which maintain a thermal barrier between the substance retained in the server and the ambient atmosphere. One form of server includes an outer housing generally enclosing or surrounding an inner chamber. The inner chamber is retained relative to the outer housing to provide a void or gap between the outside surface of the inner chamber and the inside surface of the outer housing. The area defining the void is sealed and a vacuum is drawn to evacuate the void. As a result, an evacuated void or space is provided between the inner chamber and the outer housing as in insulating barrier.

A second form of server may include the inner chamber and outer housing configuration without the evacuated space between these structures. In this embodiment, the space may be left without evacuating the space or may be filled partially or completely with an insulating material of almost any form including solids, liquids and gasses.

The servers as described may be used to retain a hot substance such as a beverage or may be used to retain a cold substance. A more specific example of an application of such a server is in the coffee industry. By way of example but not limitation, servers may be used to collect and retain fresh brewed coffee for subsequent dispensing. These servers are produced with an outlet or dispensing tube generally positioned at the bottom of the server to allow coffee to be dispensed from the server under gravity. One of the problems with the dispense tube is that the dispense tube typically extends from the inner chamber through a bottom or base portion of the housing. The dispense tube extends from the inner chamber through the base portion of the housing and to a position where it connects to a dispensing nozzle or faucet. Generally, the faucet is positioned relative to the outer housing for access and control by a user. The problem with the prior art configuration is that the dispense tube extends a distance between the inner chamber and the faucet or nozzle and is exposed to ambient atmosphere. Attempts to insulate this tube with foam insulation, while useful, may not have been optimal.

### DESCRIPTION OF THE DRAWINGS

FIG. 1 is a diagrammatic, side cross-sectional view of a server having an inner chamber and an outer housing and a dispensing tube extending from the inner chamber to the outer housing with the length of the tube extending between the inner chamber and the outer housing providing a port extending through a side wall of the outer housing, with an inlet end of the dispense tube positioned off-center relative to the inner chamber;

FIG. 2 is the server as shown in FIG. 1 with the dispense tube inlet end positioned generally coincident with the center of the inner chamber;

FIG. 3 is a server with the dispense tube having the outlet end attached to a side radius and the port extending through the side wall of the outer housing;

FIG. 4 is a server with the dispense tube attached to a side radius and extending through the side wall of the outer housing;

FIG. 5 is a server with the dispense tube attached to a bottom portion of the inner chamber and offset from the center to an outer perimeter area of the inner chamber;

FIG. 6 is a server with a dispense tube attached to a sump formed in the inner chamber along the outer perimeter area and with the dispense tube communicating with the sump area at the inlet end and extending through the side wall of the outer housing;

FIG. 7 is a server in which the sump is positioned generally centrally in the server;

FIG. 8 is a diagrammatic cross-sectional view of a portion of a dispense tube which includes an outer sleeve and an inner sleeve defining an evacuated area therebetween, the first and second ends of the inner and outer sleeves are attached to seal the evacuated area;

FIG. 9 is an embodiment of the server in which a thermally insulated dispense tube such as that shown in FIG. 8 is employed;

FIG. 10 is an embodiment of a server similar to that as shown in FIG. 1 in which a support is included to support or position the inner chamber relative to the outer housing; and

FIG. 11 is a fragmentary view of a server showing the dispense tube attached to a dispensing faucet.

### DETAILED DESCRIPTION OF THE DRAWINGS

While the present disclosure may be susceptible to embodiment in different forms, there is shown in the drawings, and herein will be described in detail, embodiments with the understanding that the present description is to be considered an exemplification of the principles of the disclosure and is not intended to limit the disclosure to the details of construction and the arrangements of components set forth in the following description or illustrated in the drawings.

The present disclosure may be used in connection with a variety of beverage making machines. Terms including beverage, mixing, powder, drink and other related terms as may be used herein are intended to be broadly defined as including, but not limited to, the making of coffee, tea and any other beverages or food substances. This broad interpretation is also intended to include, but is not limited to any process of dispensing, infusing, steeping, reconstituting, diluting, dissolving, saturating or passing a liquid through or otherwise mixing or combining a beverage substance with a liquid such as water without limitation to the temperature of such liquid unless specified. This broad interpretation is also intended to include, but is not limited to beverage substances such as ground coffee, tea, liquid beverage concentrate, powdered beverage concentrate, flaked, granular, freeze dried or other forms of materials including liquid, gel, crystal or other forms of beverage or food materials to obtain a desired beverage or other food product.

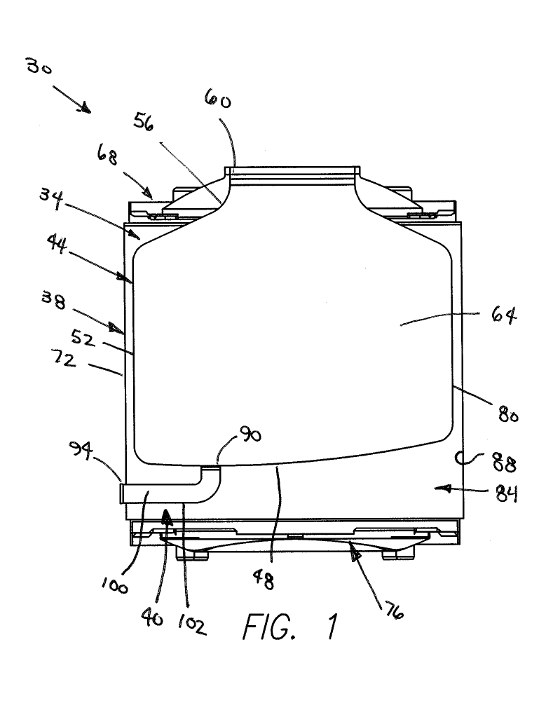

With reference to FIG. 1, a server container 30 is generally shown. The server 30 includes an inner chamber 34, an outer housing 38 and a dispense tube 40. The inner chamber 34 is defined by an inner or chamber wall 44 which extends from a bottom portion 48 of the chamber 34 upwardly along chamber side walls 52 towards a necked portion 56 defining a rim or mouth 60. The mouth 60 is provided to receive a lid or cover which can be a brew-through type lid such as Bunn-O-Matic Corporation's Safety-Fresh® brew-through lid or a sealed lid. Regardless of the type of lid used, some form of opening such as the mouth 60 is provided so that coffee may be dispensed into a cavity 64 defined by the chamber wall 44.

The outer housing 38 is comprised of an upper or top portion 68, a generally cylindrical outer side wall 72 and a base portion 76. The outer housing 38 is constructed and assembled to provide a sleeve or jacket generally in close proximity to the outside surface 80 of the inner chamber 34.

As shown in FIG. 1 and other embodiments disclosed herein, a void or gap 84 is defined between an inside surface 88 of the outer housing 38 and the outside surface 80 of the inner chamber 34. The void 84 is evacuated using known manufacturing techniques which may include, but not limited to heating and drawing a vacuum on the void with subsequent sealing of a portion through which the vacuum is drawn. Numerous manufacturing techniques are known or may be developed which may be employed to achieve the evacuation of the void 84. While evacuation is referred to herein, the evacuation may not result in an absolute vacuum but may be partial or other forms of vacuum as well. The benefit of a vacuum in the void is that it provides one form of insulation to help retain the substance contained in the cavity 64 at a desired temperature, hot, cold or otherwise. As noted herein, other forms of insulation may be provided. The vacuum, gas, liquid, solid, or insulative material provide a thermal layer which reduces the transfer of thermal energy from the container 30.

Broadly, the inner wall or sleeve 44 and the outer wall or sleeve 72 generally define what is referred to as a dual or double walled thermal container, referred to herein as a server container 30. The container 30 shown herein includes structures on the top portion 68 and base portion 76 which allow additional components to be attached to the top and base. the use of the server container 30 in a dispenser 31 is described in greater detail with reference to FIG. 11.

Having described the general characteristics of the server 30, we now turn to the structures, functions, benefits and other aspects of the dispense tube 40 as disclosed herein and its relation to the overall server assembly 30. As disclosed, the dispense tube 40 includes an inlet end 90 communicating with the cavity 64 and an outlet port 94 spaced apart from the inlet end 90. The outlet port 94 is coupled or otherwise connected to a faucet or control device 98 (see FIG. 11) of known construction or of configuration to be devised hereinafter. The present disclosure is intended to be broadly interpreted to allow the dispense tube 40 to attach to any form of faucet, nozzle or other dispensing control structure or device. Beverage or other substance retained in the cavity 64 fills a passage 100 defined by the dispense tube walls 102. Although a dispense tube 40 is shown and described, the tube 40 may have other cross-sections, configurations or geometries while not specifically illustrated herein are fully included and disclosed by way of this application.

Beverage flows from the cavity into the passage 100 and is retained therein until being dispensed by a user operating the faucet or other control device 98. While the prior art positions some, most or all of the beverage retained in the passage 100 externally of the void or gap 84, the present disclosure places the entire length of the dispense tube 40 or at least a significant portion of the tube 40 and the beverage retained in the passage 100 within the void 84. As such, the insulating benefits provided in the void 84 are provided to the beverage retained in the passage 100. This means that the insulating properties which are beneficial to the contents of the cavity 64 are also provided to the contents of the passage 100.

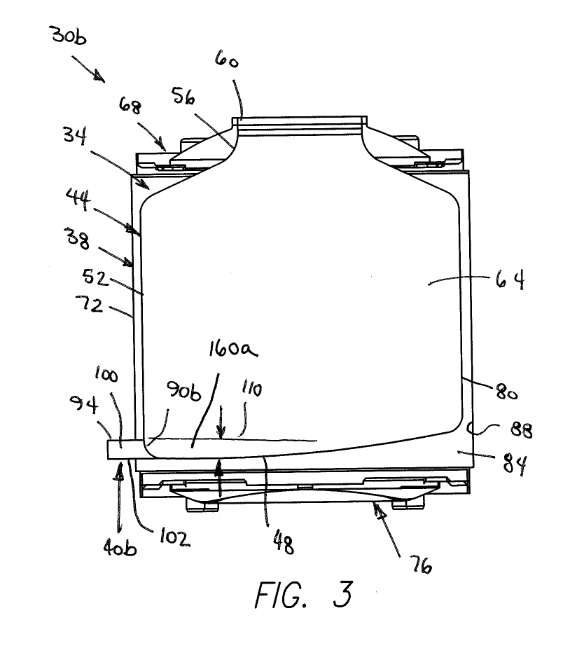

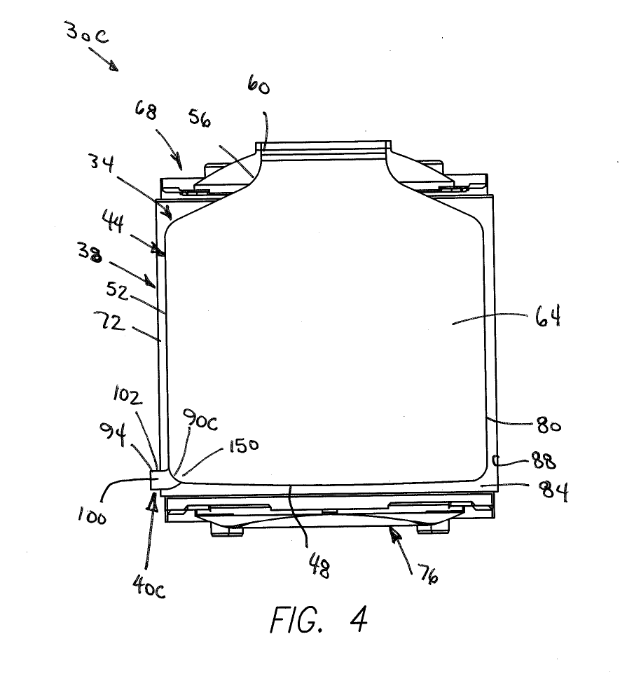

With reference to FIGS. 1, 2, 5, 6 and 7, there are benefits to a small area or “footprint” of the inlet end 90 relative to the cavity 64. This is in contrast to a larger footprint or area of contact for the inlet end 90 such as is shown in FIGS. 3 and 4. The smaller footprint and the generally horizontal orientation of the inlet end 90 helps minimize the conductive interaction between the substance retained in the cavity 64 and that as retained in the passage 100. Research indicates that the substance retained in the cavity 64, while being subject to some degree of convection current and mixing via the fill tube in the lid assembly, tends to settle into temperature layers or striations. While discreet layers are not specifically recognized, there tends to be a detectable or measurable temperature difference between the temperature of the beverage at the top level of the cavity and the bottom level of the cavity.

With this in mind, it is preferable to minimize the amount of beverage which is accessible to any generally horizontal layer of temperature or temperature zone. The intent is to minimize thermal interaction of liquid in the passage 100 to liquid in the cavity 64. The interaction is minimized by reducing the thermal mass of liquid in the passage 100 that contacts the liquid in the passage 64. All liquids at faucet elevation will eventually come to room temperature due to their strong thermal connection with the faucet. The reduced size footprint, minimized to the diameter of the passage 100 at the inlet end 90 reduces the size or area which can interact with the other temperature layers. The embodiments as shown in FIGS. 3 and 4, while providing improved thermal characteristics due to insulating a significant portion of the dispense tube between the inner chamber 34 and the outer housing 38 may expose the entire contents of the passage 100 to a series of layers ranging from the bottom 48 to the height or diameter 110. With reference to FIG. 3, as can be seen by the dimension line defining the diameter 110, the volume between the bottom of the server and the line 110 is larger than the area exposed to a small footprint inlet end 90 as shown in other figures.

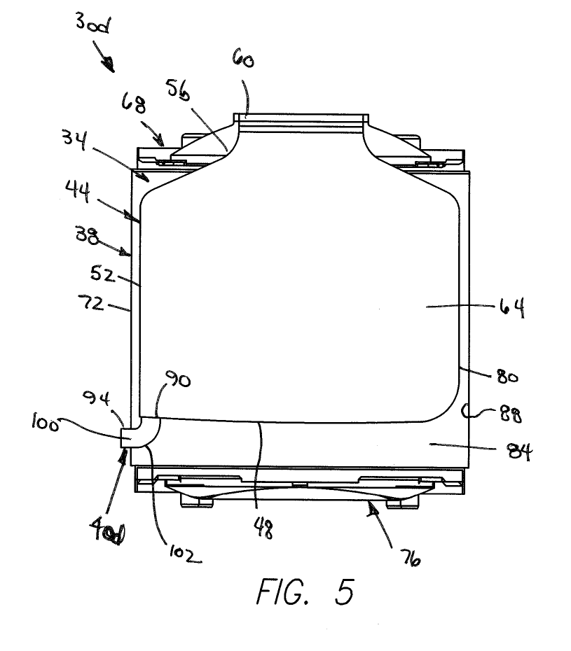

The reduced size footprint or layer at the inlet end 90 also produces less heat transfer area thereby helping to maintain the heat in the passage 100 and in the cavity 64. If heat transfers from the beverage retained in the passage 100 to the faucet, the volume or rate of heat transfer from cavity 64 is limited by the size of the inlet end 90. Additionally, it may be desirable to reduce the volume of beverage retained in the passage 100 such as shown in the reduced size passage 100b shown in FIG. 5. Other variations of the dispense tube 40 are shown in the various figures as described in further detail herein below. Each of the embodiments in FIGS. 1-7 include an embodiment of the dispense tube 40 which allows beverage to be dispensed from the cavity 64 through the dispense tube passage 100 to the nozzle or faucet 98. Each of these embodiments also provides an example of retaining the dispense tube 40 in the void 84 between the outer housing 38 and the inner chamber 34.

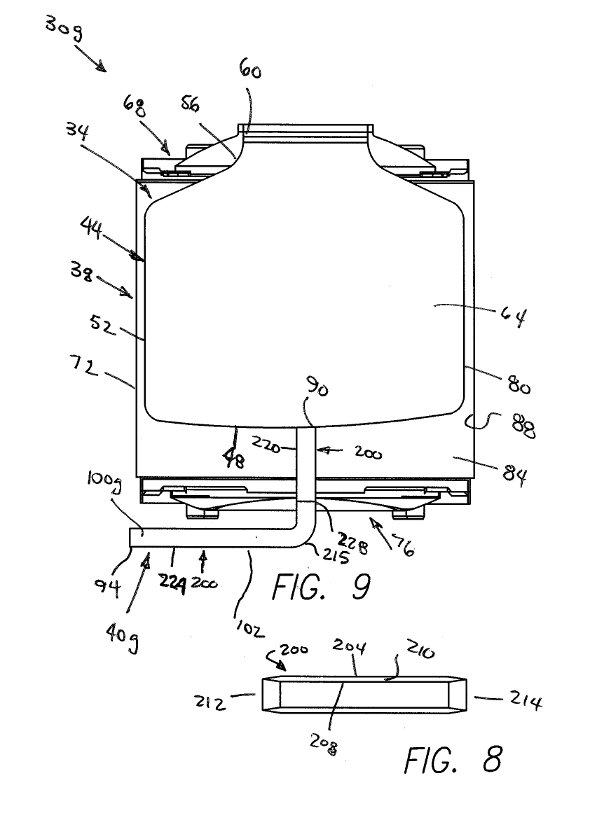

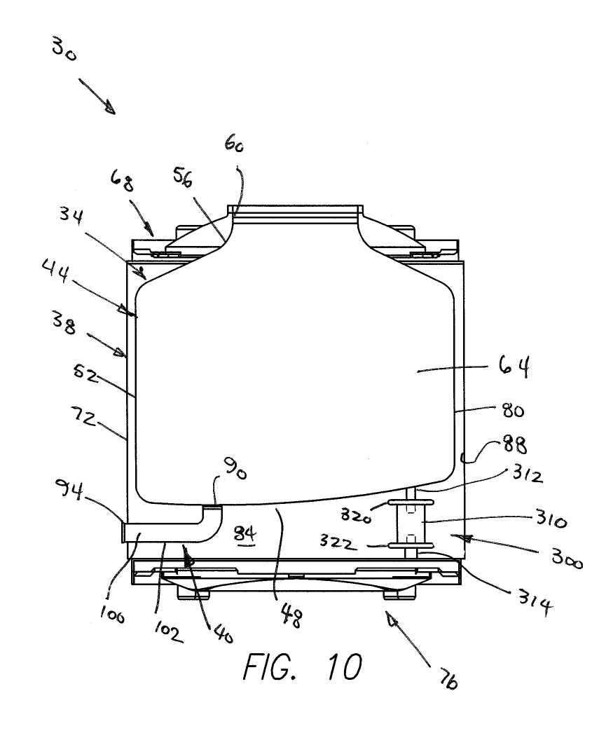

Another embodiment of the disclosed server is shown in FIGS. 8 and 9. In this embodiment, a thermally insulated tube 200 is provided. The thermally insulated tube includes an outer sleeve 204 and an inner sleeve 208 spaced inwardly of the outer sleeve 204. Generally, the two sleeves are formed in a coaxial arrangement and define an evacuated area 210 therebetween. A first end 212 and a second end 214 are formed so that the inner and outer sleeves 208, 204 are brought together and sealed. Sealing of the first and second ends 212, 214 allows a vacuum to be drawn on the evacuated area or space 210. This results in a dispensing tube 200 which has the insulating benefits of the insulated void 84 as described above. In this regard, the insulated dispense tube 200 is shown in an embodiment of FIG. 9, in which the dispense tube 200 is generally centrally located in the server 30. This configuration of the dispensing tube 200 helps to maintain an evacuated thermally insulated passage 100a from the cavity 64 to the outlet port 94.

As shown in FIG. 9, this tube may be provided in two pieces including a first section 220 and a second section 224. The first section 220 allows the inner chamber 34 to be manufactured with the outer housing 38 and the corresponding base 76 in an axially aligned manner. The second section 224 can be attached (228) to the first section 220 to provide a bend or elbow 215 and thereby deliver beverage to a side position mating the outlet port 94 with a faucet.

The insulated dispensing tube 200 may be employed in any one of the configurations shown in these illustrations as well as other configurations which are not specifically illustrated. It is believed that the teachings provided herein will allow one of ordinary skill in the art to implement these structures to provide the disclosed functions without undue experimentation.

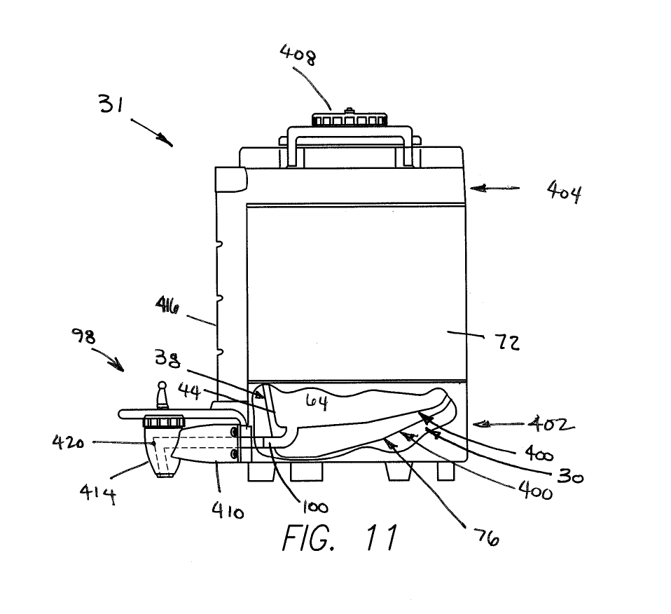

As an additional consideration, as shown in FIG. 10, the dispense tube 40 configuration as shown in FIG. 1 is provided. In some manufacturing situations it may be helpful or necessary to provide a structure 300 to help support, or position the inner chamber 34 relative to the outer housing 38. One or more structures 300 of varying sizes and dimensions as well as geometries or configurations may be provided. Generally it is envisioned that such a structure 300 will include at least of a portion 310 which is thermally insulating and/or thermally non-conductive. While thermally conductive structures may be used, and are fully within the scope of the present disclosure, it may be useful to provide a thermally non-conductive or thermally insulating structure 300. Use of a structure 300 will further enhance the temperature retaining characteristics of the server. Additionally, the support 300 may provide structural support or merely spacing. Additionally, the structure may be beneficial while retaining beverage or may not be needed while retaining beverage. For example, a structure 300 may only be necessary during the fabrication process to help maintain the gap during heating, evacuating or other process steps. Generally it is expected that the structure 300 will be formed of some material portion 310 of which is thermally non-conductive or thermally insulating. Also, in a configuration in which the void 84 is evacuated, it is anticipated that the materials used for the support 300 will be generally resistant or unaffected by the forces and temperatures of the evacuation processing step.

As illustrated, a general configuration of a support 300 is provided. The support includes a first and second positioner 312, 314 respectively attached to the inner chamber 34 and outer housing 38. The non-conductive portion or thermally insulating portion 310 is positioned between the positioners 312, 314 and, as shown, receives 316, 318 a portion of the corresponding positioners 312, 314. Additionally, a flange 320, 322 may be provided at each end of the structure 310 to help distribute forces over a larger area. It is envisioned and fully within the scope of the disclosure that numerous variations on the structure 300 may be developed and used by others. The choice of materials may have an impact on the structure and function of the support 300 but will generally provide the same overall function.

It is also envisioned that the support or positioning device 300 may be used in any orientation, geometry, position or any other configuration as might be beneficial or otherwise required to produce the structures as disclosed herein. Additionally, such supports 300 may be used in other configurations to provide desired results beneficial to the overall structure, function, assembly and fabrication of the server. It is envisioned that the support 300 may be used in any one of the other embodiments specifically shown herein as well as variations of the embodiment which may be designed and developed based on the teachings provided herein.

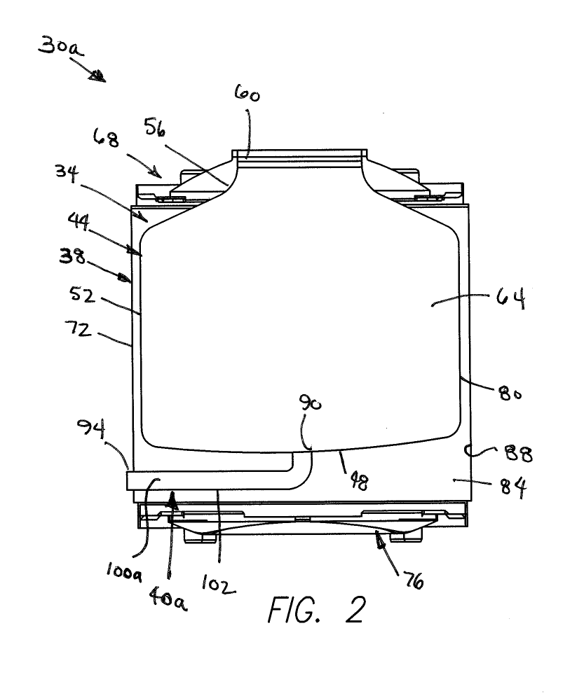

Turning now to the embodiment as shown in FIG. 2, the dispense tube 40a generally has a longer passage 100a than that as shown in FIG. 1. Additionally, the inlet end 90 is positioned generally centrally of the inner chamber 34 with the bottom portion 48 generally sloping inwardly towards the center. This configuration may be beneficial in some situations such that there is some additional degree of symmetry in the configuration of the inner chamber 34. The symmetry may help facilitate efficient and cost-effective formation of the inner chamber 34 by drawings, spinning or other manufacturing processes which benefit from axially symmetric configurations. The configuration of the dispense tube 40a provides the same general configuration such that it places the passage 100a in communication with the cavity 64 for dispensing beverage through the passage 100a. The inlet end 90 is attached to the inner chamber 34 with the outlet port 94 extending through the outer housing 38.

It should also be noted that in the various configurations and disclosures provided herein that the general attachment of the dispense tube to the structures is by way of welding. However, it will be appreciated that other materials might be suitable for a particular set of parameters used in manufacturing the server 30. For example, it is envisioned that plastics, composites, glass materials, or other single component or multiple component materials may be used in the formation of servers. Additionally, not all servers may require the level of thermal insulating provided by an evacuated void 84. As such the overall structure may be conducive to other configurations using insulating materials yet benefiting from insulating the dispense tube 40 in a gap 84 provided between the inner chamber 34 and the outer housing 38.

With regard to FIG. 3, the bottom portion 48 has been configured with a version of a sump 160a to provide some degree of flow towards the dispense tube 40b. Other configurations of the bottom portion 48 may be provided to provide the similar function as shown and described herein. Additionally, it will be appreciated based on the teachings herein and by those of ordinary skill in the art that the attachment of the dispense tube 40 may require some flaring, forming or other alteration of the corresponding portion of the chamber wall 44 to provide a preferred form of attachment. Specific details showing attachment of the dispense tube 40 to the various configurations of the inner chamber 34 and outer housing 38 are not specifically shown herein. It is believed that those of ordinary skill in the art will appreciate how to provide such attachments without undue experimentation.

With regard to FIG. 4, the dispense tube 40c has been attached to an outer perimeter area corner or radius 150. The general structure and manufacture of the inner chamber 34 generally results in corners such as that as shown by reference number 150 being formed with some measurable radius. In other words, discreet right-angle, obtuse or acute angle corners are not generally employed in such a structure. It is envisioned and fully within the scope of the present disclosure that angled corners are to be broadly included in the overall teachings provided herein. Additionally, as might be appreciated by the teachings and disclosure provided herein, the placement of the outlet port 94 through the outer housing 38 side wall 72 may result in a small portion of the outlet port 94 extending through the side wall 72. Generally, in one variation of manufacture, the extending portion of the outlet port 94 is generally equal to or slightly less than the combined dimension of the gap 84 on opposite side walls of the inner chamber 34 and outer housing 38. In other words, the generally axially oriented assembly of the server 30 as shown and described herein may result in only a small portion of the outlet port 94 extending from the outer housing 38. Even if the manufacturing process results in this portion of outlet port 94 extending through the outer housing 38, it is envisioned that additional extensions may be attached to the outlet port 94 or otherwise engage therewith for communication between the passage 100 and a corresponding faucet 98.

In FIG. 5, a short generally right-angle dispense tube 40d is provided. The dispense tube is attached to a bottom portion 48 of the inner chamber 34 and generally does not extend from a side wall thereof. The dispense tube 40d is generally positioned at the maximum position along the outer radius of the bottom portion 48 thereby minimizing the length of the passage 100 between the inner chamber 34 and outer housing 38.

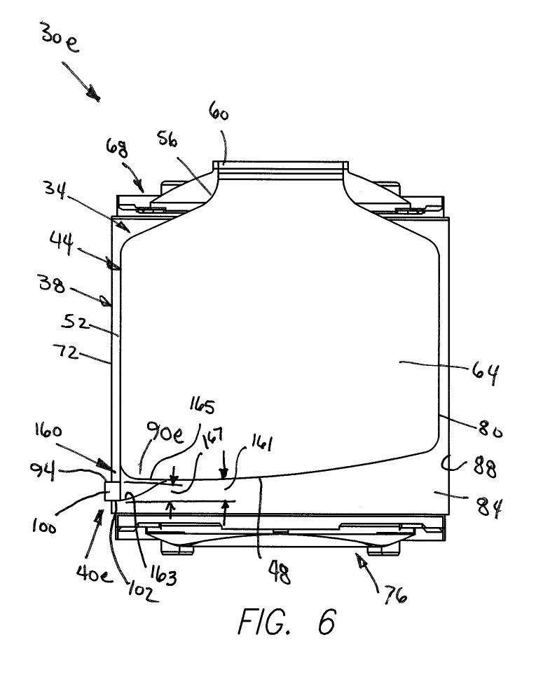

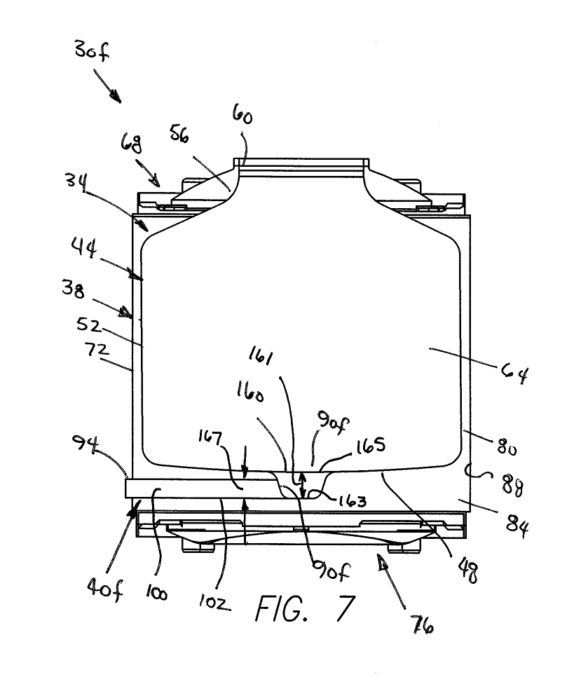

As shown in FIGS. 6 and 7, a sump 160 is provided. The sump 160 is a low lying, generally small volume of the cavity 64 which is positioned at a lowermost portion of the cavity 64 for the collection and draining of beverage from the cavity 64. The sump 160 provides a structure on the inner chamber 34 for attachment of a dispensing tube. In the configuration shown in FIG. 6, the sump 160 is positioned off to the side or outer perimeter of the inner chamber 34. Sumps 160 of this configuration have generally been known, for example Bunn-O-Matic Corporation has used a similar sump in a product referred to as “Soft Heat®” servers. An example of a sump is used in a server as shown in U.S. Pat. No. 6,070,771 which, along with any related continuations, are incorporated herein by reference in their entirety. The '771 patent is assigned to the assignee of the present disclosure. The sump as shown in the '771 patent is a rather small sump and may not provide all of the benefits of the sump as disclosed herein. The sump 160 helps to reduce the footprint or area 90e, 90f, respectively as shown in FIGS. 6 and 7. The sump 160 as disclosed is dimensionally different from that as shown in the '771 patent. In this regard, the sump is dimensioned such that the dimension 161 between A bottom of the sump 163 and a rim of the sump 165 is generally equal to or greater than the cross-sectional dimension 167 of the passage 100. This helps to facilitate the segregation of the temperature striations which might otherwise have an affect on the beverage retained in the passage 100.

As an additional consideration in manufacturing the server 30 as described herein, the inner chamber 34 may be angled or canted when being positioned in the area defined by the side wall 72 of the outer housing 38. This may allow for increasing the length of the dispense tube 40 which may be attached to the inner chamber 34 prior to final assembly. Additionally, it may be possible to provide the base portion 76 as a separate sub-assembly. This might allow the attachment of a dispense tube to a corresponding portion of the inner chamber 34 after the rim or mouth 60 has been attached to the upper portion 68 of the outer housing 38. After the dispense tube 40 is inserted through a corresponding opening of the outer housing 38, sidewall 72 proximate to the outlet port 94 the inlet end 90 can be attached to the corresponding portion of the inner chamber 34. After attaching the dispense tube 40 to the inner chamber 34, the base 76 can be attached to the corresponding portion of the side wall 72 to seal or otherwise enclose the void 84.

FIG. 11 shows an embodiment of the dispenser 31 including a server container 30 showing a fragmentary portion of the server 400 shown in a solid illustration of the outside of a server. In this embodiment a base or foot 402 is provided below the server 30 body generally attached to the base 76. The base 402 helps provide a support for the server 30. An upper portion 68 or top enclosure 404 is provided attached to the upper portion of the server 30. A lid or closure 408 is provided on top of the server generally enclosing or sealing the mouth 60 (see the prior FIGS.). The faucet 98 is attached to the base 402 with a passage 420 provided through the faucet body 410 and communicating with the nozzle 414 to allow liquid to flow from the passage 100 through the nozzle 98. Generally, the side 72 of the dispenser 31 is the same as the server container 30, however an additional housing or outer layer may be provided over the outside 72 of the container 30.

In some embodiments, a sight gauge 416 may be provided on the overall structure with a portion of the sight gauge communicating with the passage 100 so that a quantity of beverage may flow into the sight gauge. Generally, such sight gauge would be of narrow dimension so as to minimize the volume of beverage which may be contained in the sight gauge. Minimizing the volume of beverage retained in the sight gauge helps reduce the temperature loss between the beverage retained therein and the beverage retained in the cavity 64.

The server 30 as disclosed herein provides an evacuated or vacuum insulated path from the inner chamber 34 to the faucet 98. This helps to minimize the heat transfer and maximize the heat retention of the beverage retained in the cavity 64. Various configurations for attaching the dispense tube 42 to the inner chamber 34 are disclosed herein. Other embodiments may be developed based on these teachings and are fully within the scope of the disclosure provided herein.

The top of the server terminates in any manner which is now known of hereafter developed. While an embodiment showing a cover or lid 408 has been disclosed, other versions are fully within the scope of this disclosure. For example, the server 30 as disclosed may be used with an air pot or other pressurizing dispensing servers. Additionally, while it is anticipated that the server 30 may be used with a heated beverage, other variations of food or substances may be retained in and dispensed from such a server 30 and receive the benefits from the teachings provided herein.

While an evacuated void 84 is described herein and, in some embodiments may be preferred, other materials which are now know or hereafter discovered and developed may be used for insulating the void 84. Such materials may include, but are not limited to foams, gels, liquids, other gases, or any other material or absence of material may be provided to produce desired insulating characteristics to help retain the heat, reduce temperature or prevent heat transfer from the beverage retained in the cavity 64.

While a variety of dimensions and proportions are shown and described herein, the dimensions generally are not limiting unless specifically identified as being limiting. Additionally, the spacing and dimensions as well as proportions or other characteristics may be changed to accommodate processing or manufacturing requirements or characteristics. Structures, spacing and dimensions such as the radii, reinforcements, welds and other internal or external structures may be modified as necessary to achieve desired results. The disclosed structures and functions help to maintain the flavor characteristics of beverages retained in the cavity 64 and improve, maintain, maximize or optimize longevity of the beverage retained therein. This adds to the overall enjoyment of the beverage served from the server 30 and enhances the resulting benefits to the user of a server such as a restaurant, fast food service or other provider of beverages.

While embodiments have been illustrated and described in the drawings and foregoing description, such illustrations and descriptions are considered to be exemplary and not restrictive in character, it being understood that only illustrative embodiments have been shown and described and that all changes and modifications that come within the spirit of the invention are desired to be protected. The applicants have provided description and figures which are intended as illustrations of embodiments of the disclosure, and are not intended to be construed as containing or implying limitation of the disclosure to those embodiments. There is a plurality of advantages of the present disclosure arising from various features set forth in the description. It will be noted that alternative embodiments of the disclosure may not include all of the features described yet still benefit from at least some of the advantages of such features. Those of ordinary skill in the art may readily devise their own implementations of the disclosure and associated methods, without undue experimentation, that incorporate one or more of the features of the disclosure and fall within the spirit and scope of the present disclosure and the appended claims.

1. A server for use with a beverage dispenser, the server including an inner wall defining a cavity for retaining a volume of beverage, an outer wall generally spaced from and surrounding the inner wall, and a dispense passage extending between the inner wall and the outer wall, the dispense passage communicating with the cavity and extending to a position along a side of the outer wall and the dispense passage extending through the outer wall for dispensing of beverage from the server.

2. The server of claim 1, wherein the inner wall and outer wall are sealed with a gap generally defined by the volume between the inner wall and the outer wall, the gap being evacuated to provide a vacuum thermal layer.

3. The server of claim 1, wherein the inner wall and outer wall are sealed with a gap generally defined by the volume between the inner wall and the outer wall, the gap containing a gas to provide a thermal layer.

4. The server of claim 1, wherein the inner wall and outer wall are sealed with a gap generally defined by the volume between the inner wall and the outer wall, the gap containing a liquid to provide a thermal layer.

5. The server of claim 1, wherein the inner wall and outer wall are sealed with a gap generally defined by the volume between the inner wall and the outer wall, the gap containing a solid to provide a thermal layer.

6. The server of claim 1, wherein the inner wall and outer wall are sealed with a gap generally defined by the volume between the inner wall and the outer wall, an insulating material retained in the gap to provide a thermal layer.

7. The server of claim 6, wherein the insulating material is an insulating foam material.

8. The server of claim 1, further comprising a faucet positioned for communication with the dispense passage to provide controllable dispensing of beverage from the server.

9. The server of claim 1, wherein an inlet port of the dispense passage communicates with the cavity and an outlet port of the dispense passage extends though the outer wall with the dispense passage defining a tube there between.

10. The server of claim 9, wherein the inner wall and outer wall define a gap there between with the tube extending through the gap.

11. The server of claim 10, wherein the inlet port is positioned generally centrally in the cavity.

12. The server of claim 10, wherein the inlet port is positioned generally off set from the center of the cavity.

13. The server of claim 10, wherein the inlet port is positioned generally along a side of the inner wall.

14. The server of claim 10, wherein the inlet port is positioned extending through a radiused area defined between a bottom and a side of the inner wall.

15. The server of claim 9, wherein the inner wall and outer wall define a gap there between, at least the inner wall defining a sump with the inlet port communicating with the sump.

16. The server of claim 15, wherein the sump is positioned proximate to a side of the inner wall.

17. The server of claim 15, wherein the sump is positioned spaced from a side of the inner wall.

18. The server of claim 15, wherein the sump is positioned generally centrally in the cavity defined by the inner wall.

19. The server of claim 15, wherein the sump has a generally vertical dimension which is at least generally equal to a corresponding dimension of the inlet port.

20. The server of claim 15, wherein the sump has a generally vertical dimension which is at generally equal to or greater than a corresponding dimension of the inlet port.

21. The server of claim 15, wherein the sump is sized and dimensioned to reduce the heat transfer of the beverage retained in the passage.

22. The server of claim 15, wherein the sump defines a mouth proximate to and communicating with the cavity.

23. The server of claim 21, wherein the cross section area of the a mouth is sized and dimensioned to reduce the heat transfer of the beverage retained in the passage.

24. The server of claim 15, wherein the sump defines a volume proximate to and communicating with the cavity.

25. The server of claim 24, wherein the volume of the sump is sized and dimensioned to reduce the heat transfer of the beverage retained in the passage.

26. The server of claim 9, further comprising the tube being defined by an inner sleeve and an outer sleeve spaced from the inner sleeve, a sealed evacuated volume being defined between the sleeves for providing a thermal layer.

27. A server for use with a beverage dispenser, the server including an inner wall defining a cavity for retaining a volume of beverage, an outer wall generally spaced from and surrounding the inner wall, a sump defined in at least the inner wall, and a dispense passage communicating with the sump and extending between the inner wall and the outer wall, the dispense passage extending to a position along a side of the outer wall and extending through the outer wall for dispensing of beverage from the server.

28. The server of claim 27, wherein the inner wall and outer wall are sealed with a gap generally defined by the volume between the inner wall and the outer wall, the gap being evacuated to provide a vacuum thermal layer.

29. The server of claim 27, wherein an inlet port of the dispense passage communicates with the cavity and an outlet port of the dispense passage extends though the outer wall with the dispense passage defining a tube there between.

30. The server of claim 27, wherein the inner wall and outer wall define a gap there between with the tube extending through the gap.

31. The server of claim 27, wherein the inlet port is positioned generally along at least a side of the inner wall.

32. The server of claim 27, wherein the sump is positioned proximate to a side of the inner wall.

33. The server of claim 27, wherein the sump is positioned spaced from a side of the inner wall.

34. The server of claim 27, wherein the sump is positioned generally centrally in the cavity defined by the inner wall.

35. The server of claim 27, wherein the sump has a generally vertical dimension which is at least generally equal to a corresponding dimension of the inlet port.

36. The server of claim 27, wherein the sump has a generally vertical dimension which is at generally equal to or greater than a corresponding dimension of the inlet port.

37. The server of claim 27, wherein the sump is sized and dimensioned to reduce the heat transfer of the beverage retained in the passage.

38. The server of claim 27, wherein the sump defines a mouth proximate to and communicating with the cavity.

39. The server of claim 38, wherein the cross section area of the mouth is sized and dimensioned to reduce the heat transfer of the beverage retained in the passage.

40. The server of claim 27, wherein the sump defines a volume proximate to and communicating with the cavity.

41. The server of claim 27, wherein the volume of the sump is sized and dimensioned to reduce the heat transfer of the beverage retained in the passage.

42. The server of claim 27, further comprising a faucet positioned for communication with the dispense passage to provide controllable dispensing of beverage from the server.

43. A beverage dispenser including a server, the server having an inner wall defining a cavity for retaining a volume of beverage, an outer wall generally spaced from and surrounding the inner wall, and a dispense passage extending between the inner wall and the outer wall, the dispense passage communicating with the cavity and extending to a position along a side of the outer wall and the passage extending through the outer wall for dispensing of beverage from the server.

44. The beverage dispenser of claim 43, further comprising the server defining a top portion and a base portion, a top attached to the top portion of the server.

45. The beverage dispenser of claim 43, further comprising the server defining a top portion and a bottom portion, a base attached to the base portion of the server.

46. The beverage dispenser of claim 43, further comprising a faucet positioned for communication with the dispense passage to provide controllable dispensing of beverage from the server.

47. The beverage dispenser of claim 43, further comprising a beverage indicator communicating with beverage in the sever for providing information about the beverage in the server.

48. The beverage dispenser of claim 47, wherein the beverage indicator is a level gauge to provide information about the volume of beverage in the server.
A server for use with a beverage dispenser, the server including an inner wall defining a cavity for retaining a volume of beverage, an outer wall generally spaced from and surrounding the inner wall, a sump defined in at least the inner wall, and a dispense passage communicating with the sump and extending between the inner wall and the outer wall, the dispense passage extending to a position along a side of the outer wall and extending through the outer wall for dispensing of beverage from the server.

49. The beverage dispenser of claim 43, wherein the inner wall and outer wall of the server are sealed with a gap generally defined by the volume between the inner wall and the outer wall, the gap being evacuated to provide a vacuum thermal layer.

50. The beverage dispenser of claim 43, wherein an inlet port of the dispense passage communicates with the cavity and an outlet port of the dispense passage extends though the outer wall with the dispense passage defining a tube there between.

51. The beverage dispenser of claim 50, wherein at least the inner wall of the server defines a sump with the inlet port communicating with the sump.

52. A beverage dispenser including a double-walled server, the double-walled server having an inner wall defining a cavity and an outer wall, a dispense passage extending between the inner wall and the outer wall and communicating with the cavity, the dispense passage extending to a position along and extending through the outer wall for dispensing of beverage from the server.

53. A beverage dispenser including a double-walled server, the double-walled server having an inner wall defining a cavity and an outer wall, a sump is defined in at least the inner wall, a dispense passage communicating with the sump and extending between the inner wall and the outer wall, the dispense passage extending to a position along and extending through the outer wall for dispensing of beverage from the server.

54. A method of reducing heat loss of a beverage retained in a beverage server, the method comprising the steps of:
providing a double-walled server having an inner wall defining a cavity and an outer wall;
providing a dispense passage communicating with the cavity and extending to and through the outer wall;
delivering beverage from the cavity to through the dispense passage passing through the sides of the inner wall and the outer wall.
